(19) United States
(12) Patent Application Publication
(10) Pub. No.: US 2016/0156279 A1
(43) Pub. Date: Jun. 2, 2016

(54) Switch Unit

(71) Applicant: Igor, Inc., Johnston, IA (US)

(72) Inventor: Dwight L. Stewart, Johnston, IA (US)

(73) Assignee: Igor, Inc., Johnston, IA (US)

(21) Appl. No.: 14/556,027

(22) Filed: Nov. 28, 2014

(51) Int. Cl. H02M 7/06; H05B 33/08

(52) U.S. Cl. CPC H02M 7/06; H05B 33/0809

(57) ABSTRACT

Example embodiments relate to a switch unit configured to receive an alternating current and convert the alternating current to direct current. Example embodiments also relate to a system that uses the switch unit.

### BACKGROUND

1. Field

Example embodiments relate to a switch unit configured to receive an alternating current and convert the alternating current to direct current. Example embodiments also relate to systems that uses the switch unit.

2. Description of the Related Art

As is well known in the art, electricity provided to residential and commercial buildings is provided as an alternating current (AC). AC current typically powers devices that may be in a building or a structure.

Incandescent light bulbs include a wire filament which is heated to a high temperature when an electric current passes through it. Most incandescent light bulbs work well with either AC current or direct current (DC) and are widely used in residential and commercial lighting. In many commercial and residential buildings, AC current flows from a circuit breaker to a switch and then to a plurality of incandescent light bulbs. These bulbs are generally used for lighting a space such as a room or a hallway,

FIG. 1A is a schematic view of a conventional lighting system 10. As shown in FIG. 1, the conventional lighting system 10 may include a power source 12 (for example, an AC power source), a plurality of electrical wires, a plurality of lights 14 (comprised of a first light 16, a second light 18, and a third light 20), and a switch 22. Though not all of the wires are labeled, one skilled in the art would understand that the conventional lighting system 10 includes a hot wire 24 and a neutral wire 26 through which electric current may pass.

In FIG. 1A the switch 22 is illustrated as being in an open configuration. In the open configuration electric current is unable to flow to any of the lights 16, 18, and 20. However, when the switch 22 is closed, as shown in FIG. 1B, current may flow from the power source 12 to the lights 16, 18, and 20. In the conventional art incandescent lights are often used with such a system.

FIG. 2A is a schematic view of another lighting system 30 in accordance with the conventional art. As shown in FIG. 2A, the lighting system 30 may include a power source 32 (for example, an AC power source), a plurality of electrical wires, a plurality of lights 34 (comprised of a first light 36, a second light 38, and a third light 40), and a switch 42. Though not all of the wires are labeled, one skilled in the art would understand that the conventional lighting system 30 includes a hot wire 44 and a neutral wire 46 through which electric current may pass.

In FIG, 2A the switch 42 is illustrated as being in an open configuration. In the open configuration electric current is unable to flow to any of the lights 36, 38, and 40. However, when the switch 42 is closed, as shown in FIG. 2B, current may flow from the power source 32 to the lights 36, 38, and 40.

In FIG. 2B, the lights 36, 38, and 40 may include LEDs (light emitting diodes). Lights that include LEDs generally have an electrical efficiency that is several times better than incandescent light bulbs. LEDs, however, require direct current for operation. As a consequence, LED bulbs are generally fitted with an AC to DC converter in order to be used in conventional lighting systems that use an AC current source. As such, the lights 36, 38, and 40 generally include relatively complicated circuitry to convert the AC current provided by the power source 32 to DC current.

### SUMMARY

Applicant notes that LED bulbs have several desirable characteristics such as, but not limited to, relatively long lifespans and relatively little power consumption compared to incandescent lights. However, Applicant also notes that the LED bulbs are relatively expensive compared to incandescent light bulbs. As such, Applicant has set out to design a product which may reduce the cost of LED bulbs and lighting systems in general.

In general, example embodiments are drawn to a light switch unit having an AC to DC converter and a system using the light switch unit.

### BRIEF DESCRIPTION OF THE DRAWINGS

Example embodiments are described in detail below with reference to the attached drawing figures, wherein:

FIGS. 1A and 1B are views of a conventional lighting system;

FIGS. 2A and 2B are views of another conventional lighting system;

FIGS. 3A and 3B are views of a lighting system in accordance with example embodiments;

FIG. 4 is a schematic of a switch unit in accordance with example embodiments;

FIG. 5A is graph illustrating current as a function of time;

FIGS. 5B and 5C illustrate current flowing through the switch unit as a function of time; and

FIG. 6 is a view of a switch unit in accordance with example embodiments;

FIG. 7 is a view of a switch unit in accordance with example embodiments; and

FIG. 8 is a view of a switch unit in accordance with example embodiments.

### DETAILED DESCRIPTION

Example embodiments will now be described more fully with reference to the accompanying drawings. Example embodiments are not intended to limit the invention since the invention may be embodied in different forms. Rather, the example embodiments are provided so that this disclosure will be thorough and complete, and will fully convey the scope of the invention to those skilled in the art. In the drawings, the sizes of components may be exaggerated for clarity.

In this application, when an element is referred to as being “on,” “attached to,” “connected to,” or “coupled to” another element, the element may be directly on, directly attached to, directly connected to, or directly coupled to the other element or may be on, attached to, connected to, or coupled to any intervening elements that may be present. However, when an element is referred to as being “directly on,” “directly attached to,” “directly connected to,” or “directly coupled to” another element or layer, there are no intervening elements present. In this application, the term “and/or” includes any and all combinations of one or more of the associated listed items.

In this application, the terms first, second, etc. are used to describe various elements and components. However, these terms are only used to distinguish one element and/or component from another element and/or component. Thus, a first element or component, as discussed below, could be termed a second element or component.

In this application, terms, such as “beneath,” “below,” “lower,” “above,” “upper,” are used to spatially describe one element or feature's relationship to another element or feature as illustrated in the figures. However, in this application, it is understood that the spatially relative terms are intended to encompass different orientations of the structure. For example, if the structure in the figures is turned over, elements described as “below” or “beneath” other elements would then be oriented “above” the other elements or features. Thus, the term “below” is meant to encompass both an orientation of above and below. The structure may be otherwise oriented (rotated 90 degrees or at other orientations) and the spatially relative descriptors used herein interpreted accordingly.

Example embodiments are illustrated by way of ideal schematic views. However, example embodiments are not intended to be limited by the ideal schematic views since example embodiments may be modified in accordance with manufacturing technologies and/or tolerances.

The subject matter of example embodiments, as disclosed herein, is described with specificity to meet statutory requirements. However, the description itself is not intended to limit the scope of this patent. Rather, the inventors have contemplated that the claimed subject matter might also be embodied in other ways, to include different features or combinations of features similar to the ones described in this document, in conjunction with other technologies. Generally, example embodiments relate to a switch unit configured to receive an alternating current and convert the alternating current to direct current. Example embodiments also relate to systems that use the switch unit.

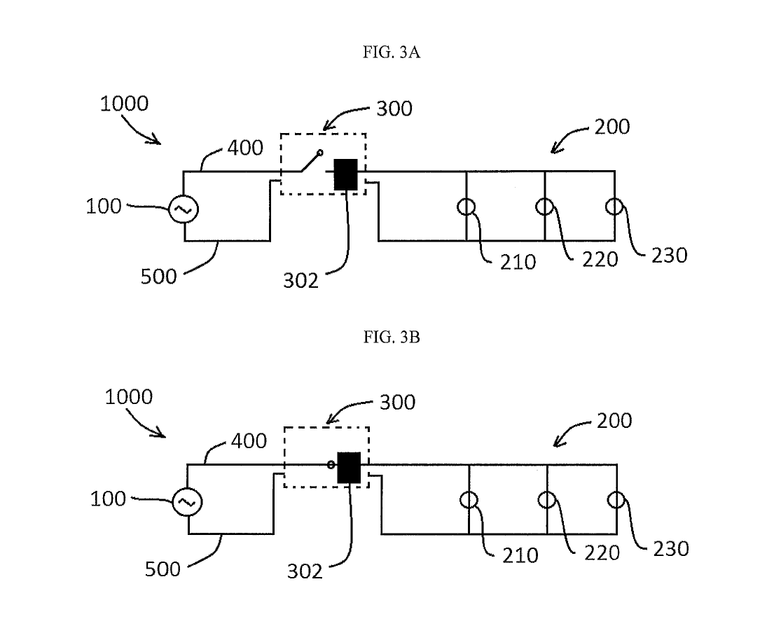

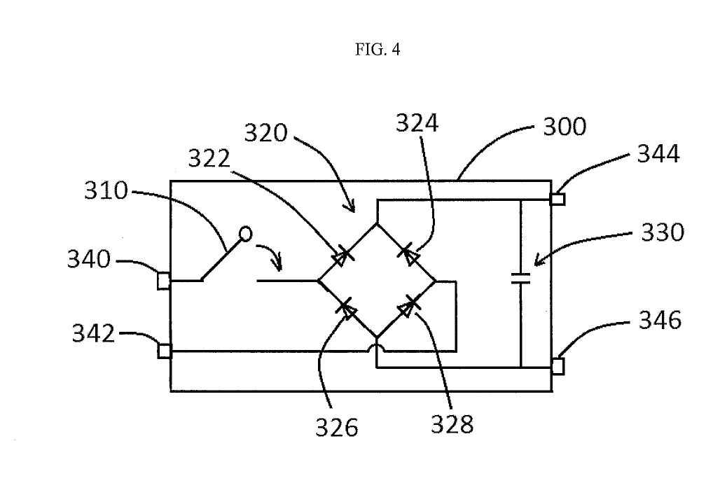

FIGS. 3A and 3B are views of a system 1000 in accordance with example embodiments. In example embodiments the system 1000 may include a power source 100 (for example, an AC power source), a plurality of wires, a plurality of lights 200, and a switch unit 300. In example embodiments, the plurality of wires may include a hot wire 400 and a neutral wire 500 as is well known in the art.

In example embodiments, the switch unit 300 may include circuitry not normally associated with a standard electrical switch. For example, in example embodiments, the switch unit 300 may include an AC to DC converter 302. Thus, in example embodiments, an AC current from the power source 100 may be delivered to the switch unit 300. The switch unit 300, in return, may use the AC current to generate a DC current which may be provided to the plurality of lights 200. Because the switch unit 300 may be configured to deliver DC to the plurality of lights 200, the plurality of lights 200 may include LEDs.

As one skilled in the art will readily appreciate, because the switch unit 300 may provide DC current to the plurality of lights 200, the plurality of lights 200 may include an LED. Further, because the current is supplied as DC current, the lights 200 themselves are not required to include AC to DC converters. As such, the lights 200 of example embodiments may be manufactured without AC to DC converters which allow them to have a reduced cost relative to conventional lights.

In example embodiments, the system 1000 is illustrated as having a plurality of lights 200 comprised of three lights 210, 220, and 230. The number of lights, however, is not meant to be a limiting feature of example embodiments. For example, rather than having three lights, the plurality of lights 200 may include more or less than three lights. In addition, rather than providing a plurality of lights, the system 1000 may include only a single light. In addition, although FIGS. 3A and 3B illustrate the lights 200 as being in parallel, this is not intended to be a limiting feature of example embodiments since the lights may alternatively be in series or a combination series and parallel.

FIG. 4 is a schematic view of the switch unit 300 in accordance with example embodiments. More specifically, FIG. 4 illustrates some of the circuitry and hardware associated with the switch unit 300. As shown in FIG. 4, the switch unit 300 may include a switch 310, a rectifier 320, and a capacitor 330. The switch unit 300 may be connected to an AC source. For example, the switch unit 300 may include a first electrode 340 that may attach to a hot wire leading from a circuit breaker and a second electrode 342 which may connect to a neutral wire. DC current may be provided to a load (for example, a light bulb or a plurality of light bulbs) via a third electrode 344 and may receive return DC electricity via a fourth electrode 346.

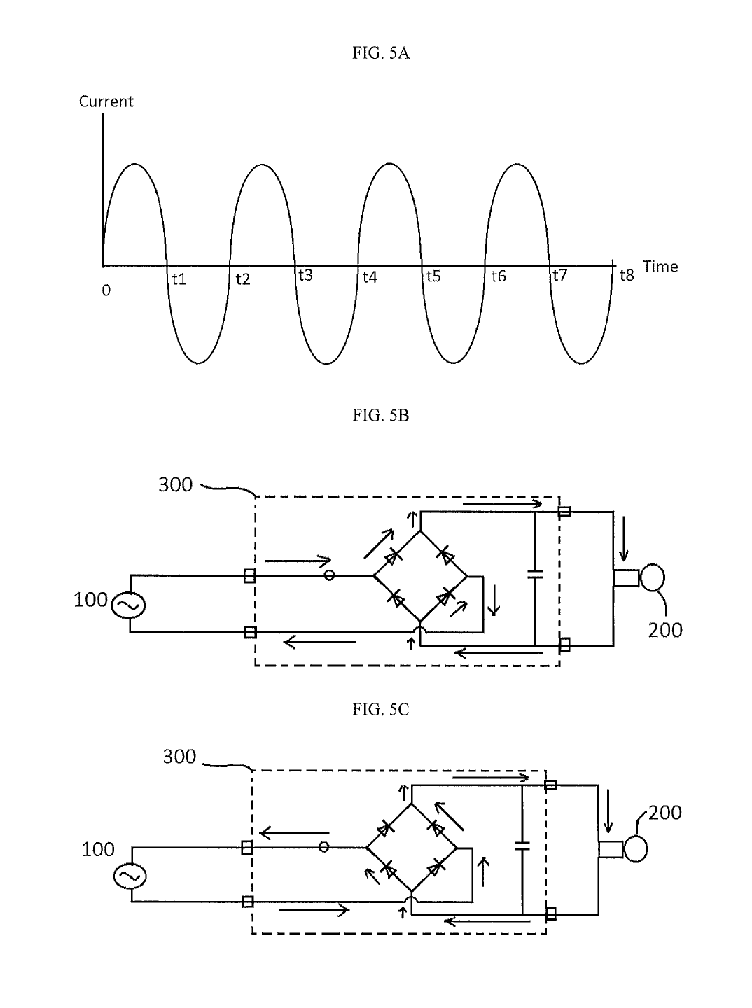

FIG. 5A is a view of AC current as a function of time. The concept of AC current is well understood by those skilled in the art. As such, only a brief description is provided. As shown in FIG. 5A, a direction of AC current flow will vary as a function of time. For example, from 0 to t1, t2 to t3, t4 to t5, and t6 to t7, current may flow in a first direction. However, during another time period, for example, from t1 to t2, t3 to t4, t5 to t6, and t7 to t8, current may flow in a second direction. As such, under AC, a direction of current flow changes as a function of time.

Referring back to FIG. 4, the rectifier 320 may be a conventional rectifier comprised of four diodes 322, 324, 326, and 328. As one skilled in the art would readily understand, AC current, during a first time period (for example 0 to t1), may flow from the first and fourth electrodes 340 and 346 to the rectifier 320 when the switch 310 is closed. The current flowing into the first electrode 340 may pass through the rectifier 320 via the first diode 322 and to the third electrode 344. The current flowing into the fourth electrode 346 may flow into the rectifier 320 and to the second electrode 342 via the fourth diode 328. In a second time period (for example t1 to t2), however, current may flow to the bridge rectifier 320 via the second electrode and fourth electrode 342 and 346. Current flowing into the switch unit 300 via the second electrode 342 may pass through the rectifier 320 via the second diode 324 and to the third electrode 344 whereas current passing through the fourth electrode 346 may enter the rectifier 320 and pass to the first electrode 310 via the third diode 326. Thus, whether current is flowing to the rectifier 320 from either the first or second electrodes 340 and 342, this current always flows to the third electrode 344 for powering loads connected thereto. The reader is directed to FIGS. 5B and 5C for drawings illustrating current flow through the switch unit 300 when the switch 310 is closed. More specifically, FIG. 5B illustrates current flowing through the switch unit 300 during time periods 0 to t1, t2 to t3, t4 to t5, and t6 to t7 and FIG. 5C illustrates current flowing through the switch unit 300 during time periods t1 to t2, t3 to t4, t5 to t6, and t7 to t8.

As noted above, the switch unit 300 may include a capacitor 330. As is readily understood by one skilled in the art, the capacitor 330 may act to both receive electrons as well as provide electrons depending on a state of the circuit to which it is attached. Thus, the capacitor 330 may receive some electrons associated with a current flowing through the rectifier 320 and later provide these electrons as the current flowing through the rectifier diminishes. As one skilled in the art will readily recognize, this acts to stabilize current provided to a load (for example, the lights 200) via the third electrode 344.

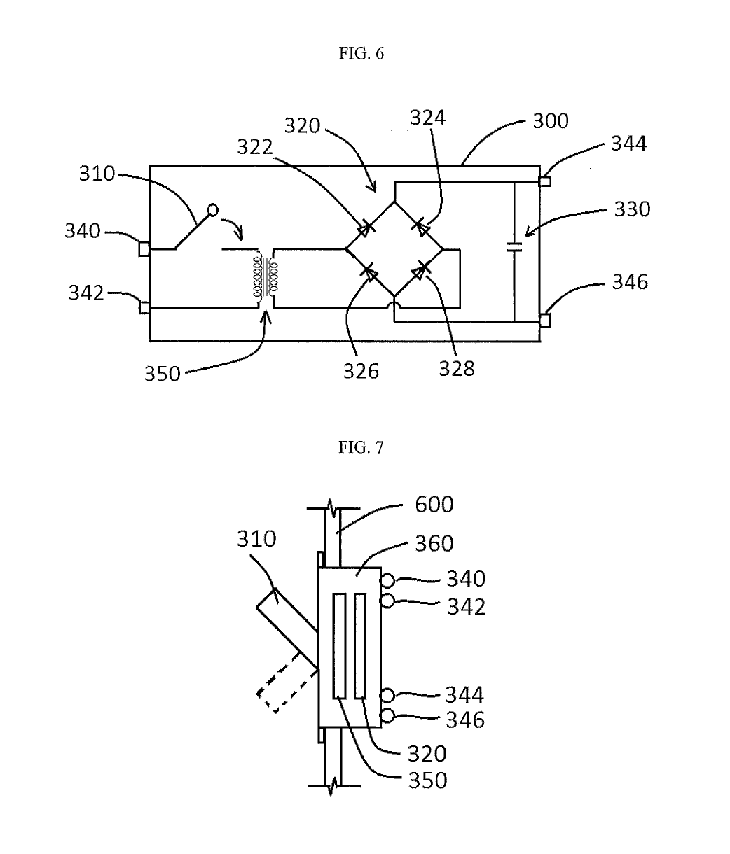

FIG. 6 is a view of the switch unit 300 with additional elements. In particular, FIG. 6 illustrates that the switch unit 300, in addition to having a rectifier 320, may also include a transformer 350. In example embodiments, the transformer 350 may be configured to reduce an input voltage, as such, the transformer 350 may be, but is not required to be, a step-down transformer. For example, the transformer 350 may be configured to reduce an input voltage from about 120 volts to about 10 volts. A reduction of the input voltage would reduce a voltage across the third and fourth terminals 344 and 346 which may be desirable in view of the loads which may be attached to the switch unit 300. For example, lights 200 may be configured to operate at a much lower voltage than is typically provided in commercial or residential buildings. By providing a transformer in the switch 300, the lights 200 associated with the switch unit 300 may not be required to have a transformer built therein, further reducing their costs. In example embodiments, the rectifier 320 and/or the rectifier 320 in combination with the transformer 350 may comprise the AC/DC converter 302.

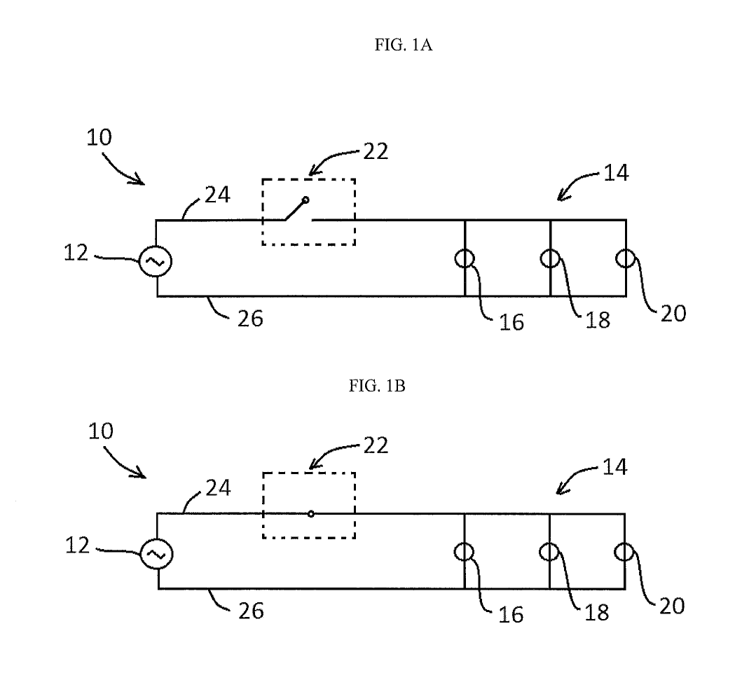

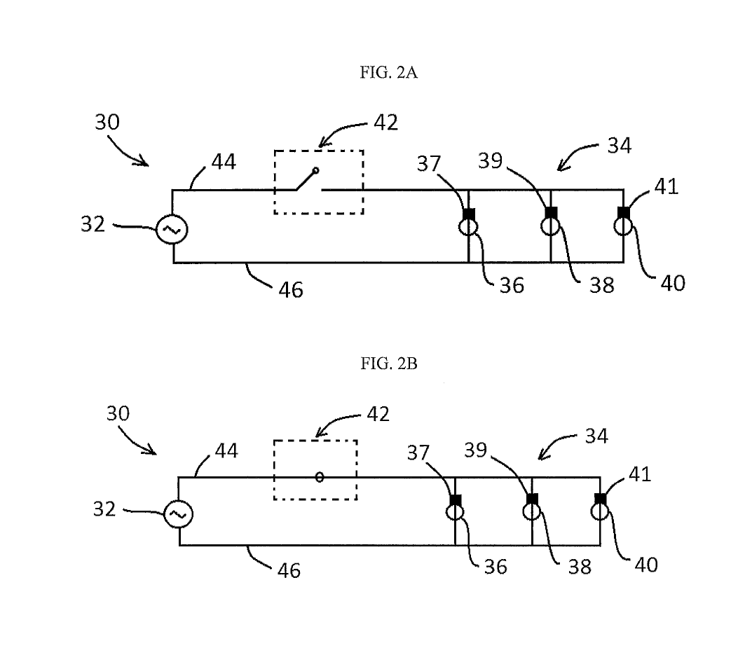

In example embodiments, because the switch unit 300 is configured to provide DC current, lights attached thereto are not required to have built in AC to DC converters. Thus, in example embodiments, the systems 1000 using the inventive switch unit 300 may utilize less expensive bulbs thereby reducing the overall costs of the bulbs and the system. Furthermore, existing electrical systems may be retrofit with the switch unit 300 to implement the system 1000 of example embodiments. For example, the conventional light switches 22 and 42 of FIGS. 1 and 2 may be replaced by the switch unit 300 and the conventional bulbs 14 and 34 may be replaced with LED bulbs which lack an AC to DC converter. Thus, in example embodiments, the system 1000 may be easily implemented in systems which already have the desired electrical wiring in place.

FIG. 7 is a view of a switch unit 300 in accordance with example embodiments. As shown in FIG. 7, the switch unit 300 may include a housing 360 which encloses various electrical components such as, but not limited to, the rectifier 320. The housing may also enclose the transformer 350. In example embodiments, the four electrodes 340, 342, 344, and 346 may be exposed relative to the housing and may allow for wiring to attach to the switch unit 300. For example, in example embodiments, a hot wire from an electrical box may attach to the first electrode 340 and a neutral wire from the electrical box may attach to the second electrode 342. A third wire attached to a light may be attached to the third electrode 344 and the neutral wire from the light may attach to the fourth electrode 346. In FIG. 7, the switch unit 300 is illustrated as being attached to a wall 600 which may be, but is not required to be, a gypsum wall. In example embodiments, the switch unit 300 may be attached to the wall 600 in a conventional manner such as using screws or other fasteners.

In example embodiments, the switch 310 may resemble a mechanical arm which is well known in the art (for example, a toggle switch), and the switch 310 may be manually operated in order to allow current to flow through the switch unit 300 and to a light or a plurality of lights. For example, in a first position the switch 310 may be in a position which closes the circuit thereby energizing lights attached thereto whereas in a second position the switch 310 opens the circuit cutting off electricity to the attached load. It should be understood that although the switch 310 has been described as being a toggle switch, example embodiments are not limited thereto as the switch 310 may be another type of switch such as, but not limited to, a pushbutton switch, a selector switch, a joystick switch, a proximity switch, a pressure switch, and/or a temperature switch.

In example embodiments the switch unit 300 may be configured to have about a same size as a conventional wall switch. For example, the switch unit 300 may have a length of about 4.5 inches and a width of about 2.75 inches. Example embodiments, however, are not intended to be limited by these sizes as a size of the switch unit 300 may vary upon the application for which it is being used. Furthermore, although the switch unit 300 of FIG. 7 is illustrated as including a housing 360 which encloses the rectifier 320 and transformer 350, the invention is not limited thereto as the housing 360 is not required to enclose the rectifier and transformer 350. Instead, the housing 360 may simply support the rectifier 320 and/or the transformer 350 without enclosing it. For example, in this latter example the housing 360 may simply resemble a plate. In the alternative, the housing 360 may simply be a common member which supports at least the rectifier 320 and the switch 310 or a common structure which supports the rectifier 320, the switch 310, and the transformer 350. It should be understood that because the switch unit 300 is considered a unit, structures such as walls and joists would not be fairly considered to be a housing within the meaning of this application.

In example embodiments, the switch unit 300 may be further configured for enhanced use. For example, in example embodiments, the switch unit 300 may be configured to operate wirelessly so that an operator may remotely adjust the lights. As another example, the switch unit 300 may further include a microcontroller for controlling, monitoring, and/or communicating with the lights. For example, in example embodiments, wiring connecting the switch unit 300 to the lights may be used to transmit not only power, but data as well. For example, in example embodiments, data may be overlaid on top of the voltage generated by the switch unit 300. In this latter embodiment, the lights connected to the switch unit 300 may include microprocessors configured to interpret whether a given control signal is meant for them and, if so, execute an algorithm.

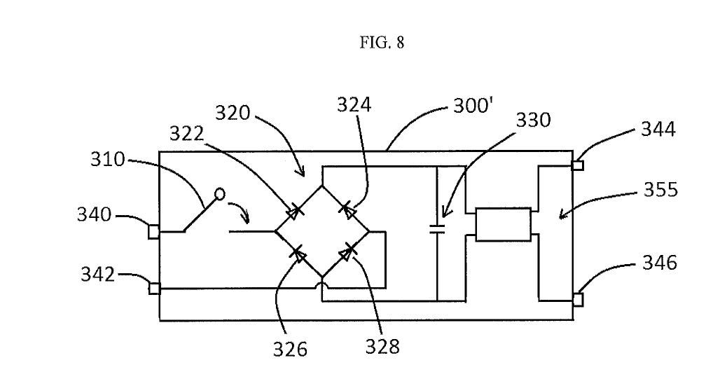

FIG. 8 is a view of another switch unit 300′ in accordance with example embodiments. In example embodiments, the switch unit 300′ may be used in lieu of thd switch unit 300.

In example embodiments the switch unit 300′ may include a DC-DC power converter 355. In example embodiments, the DC-DC power converter 355 may be configured to provide a reduced the input voltage. For example, the DC-DC power converter 355 may be configured to reduce an input voltage from about 120 volts to about 10 volts. A reduction of the input voltage would reduce a voltage across the third and fourth terminals 344 and 346 which may be desirable in view of the loads which may be attached to the switch unit 300′. For example, lights 200 may be configured to operate at a much lower voltage than is typically provided in commercial or residential buildings. By providing a DC-DC power converter 355 in the switch unit 300′, the lights 200 associated with the switch unit 300′ may not be required to have a DC-DC power converter 355 built therein, further reducing their costs.

In example embodiments, because the switch unit 300′ is configured to provide DC current, lights attached thereto are not required to have built in AC to DC converters. Thus, in example embodiments, the systems 1000 using the inventive switch unit 300′ (instead of 300) may utilize less expensive bulbs thereby reducing the overall costs of the bulbs and the system. Furthermore, existing electrical systems may be retrofit with the switch unit 300′ to implement the system 1000 of example embodiments. For example, the conventional light switches 22 and 42 of FIGS. 1 and 2 may be replaced by the switch unit 300′ and the conventional bulbs 14 and 34 may be replaced with LED bulbs which lack a DC to DC converter. Thus, in example embodiments, the system 1000 may be easily implemented in systems which already have the desired electrical wiring in place.

Example embodiments of the invention have been described in an illustrative manner. It is to be understood that the terminology that has been used is intended to be in the nature of words of description rather than of limitation. Many modifications and variations of example embodiments are possible in light of the above teachings. Therefore, within the scope of the appended claims, the present invention may be practiced otherwise than as specifically described.

What we claim is:

1. A switch unit comprising:
a switch; and
a power converter.

2. The switch of claim 1, wherein the power converter is an AC to DC converter and the power converter includes a rectifier.

3. The switch of claim 2, wherein the AC to DC converter further includes a transformer.

4. The switch of claim 2, wherein the power converter further includes a step down DC to DC power converter.

5. The switch unit of claim 1, further comprising a housing configured to support the switch and the power converter.

6. A lighting system comprising:
the switch unit of claim 1; and
a plurality of lights attached to the switch unit, wherein at least one of the lights includes an LED.

7. The lighting system of claim 6,
wherein the at least one light does not include an AC to DC converter.

8. The lighting system of claim 6, wherein the power converter is an AC to DC converter and the power converter includes a rectifier.

9. The lighting system of claim 8, wherein the AC to DC converter further includes a transformer.

10. The lighting system of claim 9, wherein the power converter further includes a step down DC to DC power converter.
